(19) United States
(12) Patent Application Publication
(10) Pub. No.: US 2012/0320931 A1
(43) Pub. Date: Dec. 20, 2012

(54) DYNAMIC SELECTION OF MAC INTERFRAME PARAMETERS IN PLC NETWORKS

(75) Inventors: RAMANUJA VEDANTHAM, ALLEN, TX (US); KUMARAN VIJAYASANKAR, DALLAS, TX (US); ANAND G. DABAK, PLANO, TX (US); TARKESH PANDE, DALLAS, TX (US); IL HAN KIM, DALLAS, TX (US)

(73) Assignee: TEXAS INSTRUMENTS INCORPORATED, Dallas, TX (US)

(21) Appl. No.: 13/524,505

(22) Filed: Jun. 15, 2012

Related U.S. Application Data
(60) Provisional application No. 61/498,929, filed on Jun. 20, 2011.

(51) Int. Cl. H04L 12/413

(52) U.S. Cl. 370/445

(57) ABSTRACT

A method of powerline communications (PLC) in a PLC network having a plurality of nodes including a first node and a second node. A first node receives a PLC signal from the second node. The first node decodes a media access control (MAC) frame of the PLC signal to determine a frame size of the MAC frame. Based on the frame size, dynamic selection of a Response Inter-Frame Space (RIFS) value from at least two candidate RIFS values and a Contention Inter-frame Space (CIFS) value from at least two candidate CIFS values is provided.

### CROSS REFERENCE TO RELATED APPLICATIONS

This application and the subject matter disclosed herein claims the benefit of Provisional Application Ser. No. 61/498,929 entitled “Selection of MAC Parameters in Narrowband PLC Networks” filed Jun. 20, 2011, which is herein incorporated by reference in its entirety.

### FIELD

Disclosed embodiments relate generally to the field of Powerline communications (PLC), and more specifically to media access control (MAC) layers for PLC communications.

### BACKGROUND

Powerline communications (PLC) include systems for communicating data over the same medium (i.e., a wire or conductor) that is also used to transmit electric power to residences, buildings, and other premises. Once deployed, PLC systems may enable a wide array of applications, including, for example, automatic meter reading and load control (i.e., utility-type applications), automotive uses (e.g., charging electric cars), home automation (e.g., controlling appliances, lights, etc.), and/or computer networking (e.g., Internet access), to name only a few.

Various PLC standardizing efforts are currently being undertaken around the world, each with its own unique characteristics. Generally speaking, PLC systems may be implemented differently depending upon local regulations, characteristics of local power grids, etc. Examples of competing PLC standards include IEEE 1901, HomePlug AV, and ITU-T G.hn (e.g., G.9960 and G.9961) specifications. Another standardization effort includes, for example, the Powerline-Related Intelligent Metering Evolution (PRIME) standard designed for OFDM-based (Orthogonal Frequency-Division Multiplexing) communications.

Powerline modems determine if the powerline medium is idle or not using virtual carrier sense (VCS). If the powerline medium has been idle for an Extended InterFrame Space (EIFS), the node/station can transmit without contention. If the powerline medium is busy, before transmitting the node/station waits a fixed time after the end of a last transmission defined by a Contention InterFrame Space (CIFS) if no response is expected from the node as depicted in FIG. 1A, or a fixed time after the end of the last transmission defined by a Response InterFrame Space (RIFS) if a response is expected (e.g., an ACK) as depicted in FIG. 1B.

An EIFS is defined for conditions when the node/station does not have complete knowledge of the state of the medium. This can occur when the station initially attaches to the network, or when errors in the received frames make the received frames impossible to decode unambiguously. If a frame is received and correctly decoded before the expiration of the EIFS, then the EIFS is cancelled. The EIFS is significantly longer than the other interframe spaces (CIFS, RIFS), providing protection from collision for an ongoing frame transmission or segment burst when any of these conditions occur.

To overcome difficult channel conditions generally observed in (low frequency) LF power lines, IEEE 1901.2 LF PLC adopted an OFDM architecture (hereafter IEEE P1901.2) using advanced modulation and channel-coding techniques to efficiently utilize the limited bandwidth of standards including the European Committee for Electrotechnical Standardization (CENELEC), Association of Radio Industries and Businesses (ARIB), and Federal Communications Commission (FCC) bands. IEEE P1901.2 is a standard for LF (less than 500 kHz) Narrow Band PLC for Smart Grid Applications. In IEEE P1901.2, CIFS is referred to as “aCIFS”, and RIFS as “aRIFS”.

The 3.4 draft specification for IEEE P1901.2 describes the RIFS and CIFS constants for the MAC layer as each being 10 symbols long, which translates to a time of 2.3 ms (symbol time of ˜0.23 ms). This is also applicable to the G3 CENELEC specification, which has RIFS and CIFS constants for the MAC layer both specified as being 10 symbols long with symbol time of 0.69 ms (total time of 6.9 ms) It has also been disclosed to reduce the RIFS and CIFS constants to a time between 0.6 and 1.0 ms. The result of this proposed reduction in RIFS and CIFS duration is that the MAC layer at the node has a much shorter time to process data received by its physical layer (PHY). The main reason for this proposed reduction is the slight increase in throughput by having smaller RIFS and CIFS times. This increase in throughput diminishes for larger (longer) frame sizes.

### SUMMARY

Disclosed embodiments provide a mechanism for powerline communications (PLC) in a PLC network which renders both the Response InterFrame Space (RIFS) and Contention InterFrame Space (CIFS) as variables by dynamically selecting these parameters for the media access control (MAC) layer based on the frame size. The dynamic selection procedure disclosed herein does not require modification to frame structures. Modems that implement dynamic selection of RIFS and CIFS values based on the frame size of a MAC frame are also disclosed, and communication devices therefrom are also disclosed.

One embodiment comprises a method of powerline communications in a PLC network having a plurality of nodes including a first node and a second node. A first node receives a PLC signal from the second node. The first node decodes a MAC frame of the PLC signal to determine a frame size of the MAC frame. Based on the frame size, dynamic selection of a RIFS value from at least two candidate RIFS values and a CIFS value from at least two candidate CIFS values are provided.

### BRIEF DESCRIPTION OF THE DRAWINGS

Reference will now be made to the accompanying drawings, which are not necessarily drawn to scale, wherein:

FIG. 1A depicts a known CIFS used when no response is expected from the node, while FIG. 1B depicts a known RIFS used when a response (e.g., an acknowledgement (ACK)) is expected from the node.

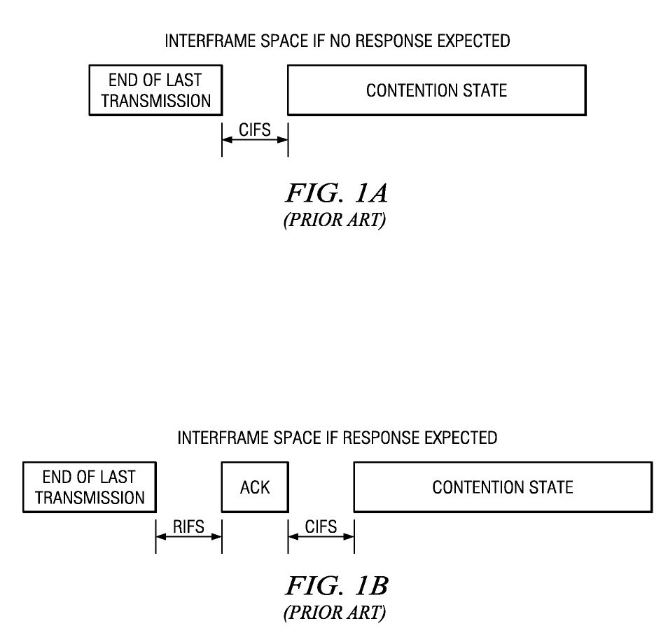

FIG. 2 is a flow chart for an example method of communications in a PLC network having a plurality of nodes including dynamic selection of RIFS and CIFS values based on the frame size of a MAC frame, according to an example embodiment.

FIG. 3 is a block diagram schematic of a communication device having a disclosed modem that implements dynamic selection of RIFS and CIFS values based on the frame size of a MAC frame using a disclosed dynamic MAC interframe space (IFS) selection algorithm, according to an example embodiment.

FIGS. 4A and 4B provide simulated throughput data using Quadrature Phase Shift Keying (QPSK), Binary Phase Shift Keying (BPSK) and ROBO modulation with the IEEE P1901.2 “long duration (standard)” using an RIFS and CIFS of 2.3 msec, and a “short duration” RIFS and CIFS of 1 msec.

### DETAILED DESCRIPTION

Disclosed embodiments now will be described more fully hereinafter with reference to the accompanying drawings. Such embodiments may, however, be embodied in many different forms and should not be construed as limited to the embodiments set forth herein. Rather, these embodiments are provided so that this disclosure will be thorough and complete, and will fully convey the scope of this disclosure to those having ordinary skill in the art. One having ordinary skill in the art may be able to use the various disclosed embodiments and there equivalents. As used herein, the term “couple” or “couples” is intended to mean either an indirect or direct electrical connection unless qualified as in “communicably coupled” which includes wireless connections. Thus, if a first device couples to a second device, that connection may be through a direct electrical connection, or through an indirect electrical connection via other devices and connections.

Disclosed embodiments render the RIFS and CIFS parameters for MAC layers as variables as opposed to constants for MAC layers in known PLC network arrangements. The values for these IFS variables are dynamically selected which allows different choices of RIFS and CIFS values based on the frame size (length) of the MAC frame.

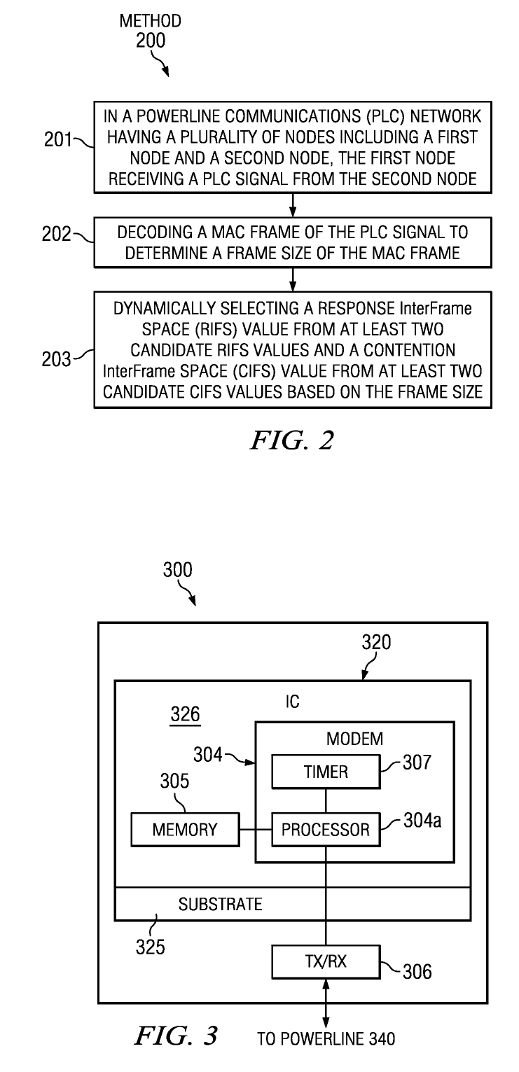

FIG. 2 is a flow chart for an example method 200 of powerline communications on a PLC channel in a PLC network having a plurality of nodes including a first node and a second node which provide dynamic selection of RIFS and CIFS values based on the frame size of a MAC frame, according to an example embodiment. Step 201 comprises the first node receiving a PLC signal from the second node. The first node can be the destination node for the PLC signal, or any other node that receives the PLC signal. Step 202 comprises the first node decoding a MAC frame of the PLC signal to determine the frame size of the MAC frame.

Step 203 comprises dynamically selecting a RIFS value from at least two candidate RIFS values and a CIFS value from at least two candidate CIFS values based on the frame size determined in step 202. For broadcast and multicast transmissions, the entire frame is decoded prior to reception of the next frame. In these scenarios, there is no ACK transmission, and hence no RIFS. As a result, RIFS and CIFS will generally be close to each other (e.g., the CIFS value can be slightly less than the RIFS value).

In one embodiment, two sets of RIFS and CIFS values are used, with the specific set/pair of RIFS/CIFS values selected depending on the size of the MAC frame relative to a threshold frame size. The threshold frame size can be based on the maximum frame size parameter provided by the PLC specification being used, such as the draft specification for IEEE P1901.2 in one particular embodiment. The destination node (and all other nodes that receive the MAC frame transmitted) will be able to determine the appropriate RIFS and CIFS values to use based on their decoding of the MAC frame to determine its frame size, and then comparison of this frame size to the threshold frame size.

In one embodiment, if the frame size is ≦ the threshold frame size, the shorter of the candidate values are used for the RIFS value and CIFS value, whereas if the frame size > the threshold frame size, the longer of the candidate values are used for RIFS and CIFS. It is also possible to have multiple values or a function for computation of RIFS and CIFS based on frame size. The source (sending) node can also determine the RIFS and CIFS values based on the frame size it transmits. This way, the selection of RIFS and CIFS can be dynamically adjusted at the source node as well as the destination node(s) based on the frame size.

The choice of the threshold frame size can be based on the expected throughput gains for choosing the shorter RIFS and CIFS values as compared to longer RIFS and CIFS values. In one particular embodiment, a value of 100 octets is used for the threshold frame size. A value of 100 bytes is representative of typical data for a short cycle read application. For a long cycle read application there are generally a few frames that are longer than 100 bytes (e.g., up to 200 bytes). The benefit of disclosed RIFS and CIFS reduction enabled by disclosed dynamic selection of RIFS and CIFS is generally reduced with increasing frame sizes, mainly because of the increase in frame transmission duration, as well as the increased probability of collision, and as a result retransmission.

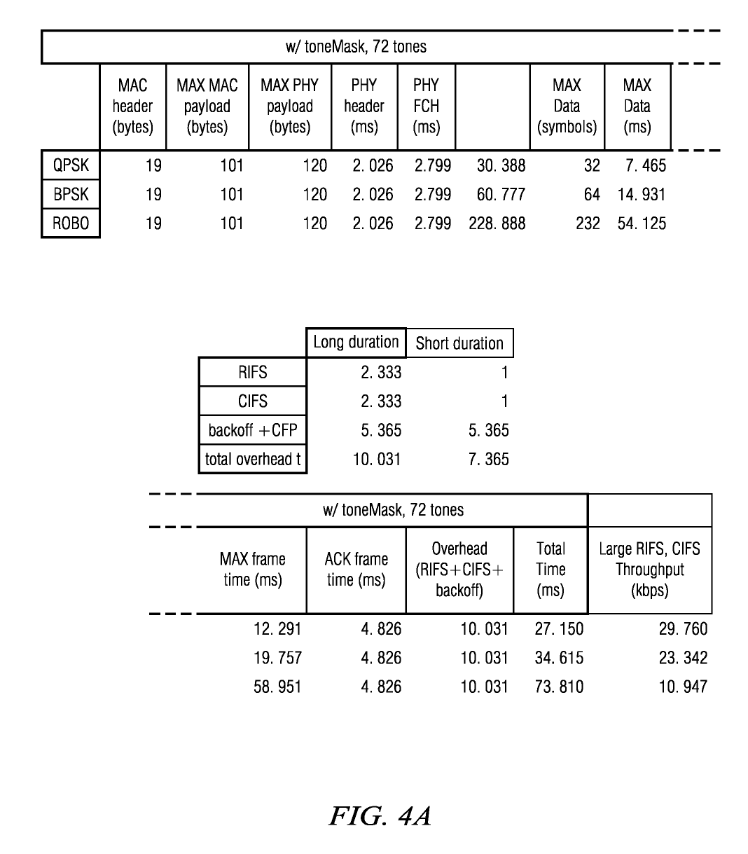

FIG. 3 is a block diagram schematic of a communication device 300 having a disclosed modem 304 that implements selection of RIFS and CIFS values based on the frame size of a MAC frame using a disclosed dynamic MAC IFS selection algorithm, according to an example embodiment. Modem 304 includes a processor (e.g., a digital signal processor, (DSP)) 304a coupled to an associated memory 305 that stores a disclosed dynamic MAC IFS selection algorithm. In operation, the processor 304a is programmed to implement the dynamic MAC IFS selection algorithm. Memory 305 can comprise static random-access memory (SRAM), for example.

Processor 304a is programmed to implement the disclosed dynamic MAC IFS selection algorithm at a service node (which includes switch nodes and terminal nodes) or at a base (data concentrator) node in the PLC communications network. Modem 304 includes a timer 307, such as for setting ACK transmission times. The PLC transceiver (TX/RX) 306 which comprises an analog front end (AFE) allows coupling of the communications device 300 to the powerline 340.

The modem 304 is shown formed on an integrated circuit (IC) 320 comprising a substrate 325 having a semiconductor surface 326, such as a silicon surface. Memory 305 may be included on the IC 320. In another embodiment the modem 304 is implemented using 2 processor chips, such as 2 DSP chips. Besides the DSP noted above, the processor 304a can comprise a desktop computer, laptop computer, cellular phone, smart phone, or an application specific integrated circuit (ASIC).

Disclosed modems 304 and disclosed communications devices 300 can be used in a PLC network to provide a networked device that in service is connected to a powerline via a power cord. In general, the “networked device” can be any equipment that is capable of transmitting and/or receiving information over a powerline. Examples of different types of networked devices include, but are not limited or restricted to a computer, a router, an access point (AP), a wireless meter, a networked appliance, an adapter, or any device supporting connectivity to a wired or wireless network

### EXAMPLES

Disclosed embodiments are further illustrated by the following specific Examples, which should not be construed as limiting the scope or content of this Disclosure in any way.

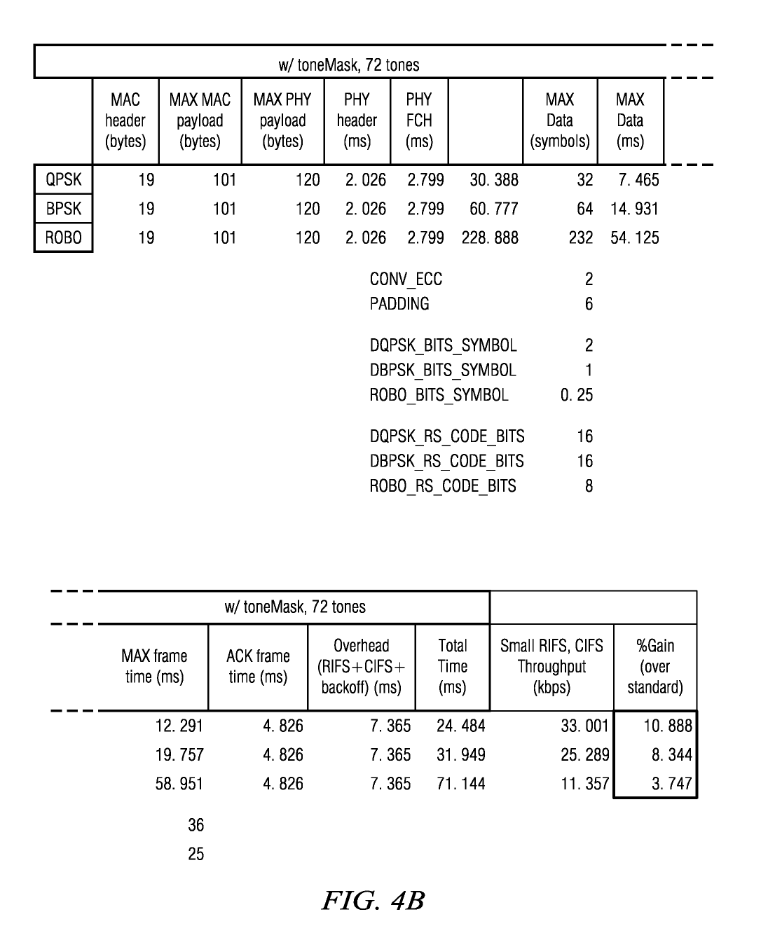

FIGS. 4A and 4B show simulated throughput data (in kbps) using QPSK, BPSK and ROBO PLC modulation with both the IEEE P1901.2 “long duration (standard)” RIFS and CIFS of 2.3 msec, and the “short duration” RIFS and CIFS at 1 msec. The backoff +CFP was held constant at 5.36 sec. ROBO modulation uses a differential BPSK (DBPSK) modulation with heavy error correction with bit repetition in time and frequency to enable highly reliable communications. For the ROBO mode, a spread spectrum is superimposed by repeating the information 4 times. The frame size of the MAC frames used in this simulation was 120 bytes.

Using the short duration RIFS and CIFS, throughput was found to be increased between 3.7% for ROBO mode and 10.9% for QPSK. QPSK modulation benefited most (a 10.9% throughput benefit) from short durations RIFS and CIFS as it has the smallest relative frame transmission time for a given frame size. As a result, the overhead introduced by the extra 7 symbols for the long duration (standard) RIFS and CIFS is larger. Since ROBO mode has the largest frame duration in time for the same frame size of the modulation modes tested, the overhead for ROBO mode was relatively small, resulting in a reduced benefit (a 3.7% throughput benefit) for ROBO mode modulation.

Many modifications and other embodiments of the invention will come to mind to one skilled in the art to which this Disclosure pertains having the benefit of the teachings presented in the foregoing descriptions, and the associated drawings. Therefore, it is to be understood that embodiments of the invention are not to be limited to the specific embodiments disclosed. Although specific terms are employed herein, they are used in a generic and descriptive sense only and not for purposes of limitation.

We claim:

1. A method of powerline communications (PLC) in a PLC network having a plurality of nodes including a first node and a second node, comprising:
said first node receiving a PLC signal from said second node;
decoding a media access control (MAC) frame of said PLC signal to determine a frame size of said MAC frame, and
dynamically selecting a Response Inter-Frame Space (RIFS) value from at least two candidate RIFS values and a Contention Inter-frame Space (CIFS) value from at least two candidate CIFS values based on said frame size.

2. The method of claim 1, further defining a threshold frame size, wherein if said frame size is less than or equal to (≦) said threshold frame size, a shorter of said candidate values are selected in said dynamically selecting for said RIFS value and said CIFS value, whereas if said frame size is greater than (>) said threshold frame size, a longer of said candidate values are selected in said dynamically selecting for said RIFS and said CIFS.

3. The method of claim 2, further comprising calculating a throughput gain using at least said shorter of said candidate values over using said longer of said candidate values to determine said threshold frame size.

4. The method of claim 3, wherein said threshold frame size is from 90 to 110 octets.

5. The method of claim 1, wherein said second node also performs said dynamically selecting to generate said RIFS value and said CIFS value based on said frame size.

6. The method of claim 1, wherein said threshold frame size is based on a maximum frame size parameter defined by a PLC specification used by said PLC network.

7. A modem, comprising:
a processor;
wherein said processor is communicably coupled to a memory which stores a dynamic media access control (MAC) InterFrame-space (IFS) selection algorithm, and wherein said processor is programmed to implement said dynamic MAC IFS selection algorithm, said dynamic MAC IFS selection algorithm:
decoding a MAC frame of a powerline communications (PLC) signal at a node in a PLC network having a plurality of nodes to determine a frame size of said MAC frame, and
based in said frame size, dynamically selecting a Response Inter-Frame Space (RIFS) value from at least two candidate RIFS values and a Contention Inter-frame Space (CIFS) value from at least two candidate CIFS values.

8. The modem of claim 7, wherein said modem is formed on an integrated circuit (IC) comprising a substrate having a semiconductor surface, and wherein said processor comprises a digital signal processor (DSP).

9. The modem of claim 8, wherein said dynamic MAC IFS selection algorithm implements defining a threshold frame size, and wherein if said frame size is less than or equal to (≦) said threshold frame size, a shorter of said candidate values are selected in said dynamically selecting for said RIFS value and said CIFS value, whereas if said frame size is greater than (>) said threshold frame size, a longer of said candidate values are selected in said dynamically selecting for said RIFS and said CIFS.

10. The modem of claim 8, wherein said dynamic MAC IFS selection algorithm implements calculating a throughput gain using at least said shorter of said candidate values over using said longer of said candidate values to determine said threshold frame size.

11. The modem of claim 9, wherein said threshold frame size is based on a maximum frame size parameter defined by a PLC specification used by said PLC network.

12. A communications device for powerline communications (PLC) at a first node on a PLC channel in a PLC network having a plurality of nodes including said first node and a second node, comprising:
a memory which stores a dynamic MAC InterFrame-space (IFS) selection algorithm,
a modem, comprising:
a processor, wherein said processor is communicably coupled to said memory, and wherein said processor is programmed to implement said dynamic MAC IFS selection algorithm, said dynamic MAC IFS selection algorithm:
decoding a MAC frame of a PLC signal to determine a frame size of said MAC frame, and
based in said frame size, dynamically selecting a Response Inter-Frame Space (RIFS) value from at least two candidate RIFS values and a Contention Inter-frame Space (CIFS) value from at least two candidate CIFS values, and
a PLC transceiver communicably coupled to said modem, said PLC transmitter transmitting a frame using said RIFS value selected in said dynamically selecting if a response is expected and using said CIFS values selected in said dynamically selecting if no response is expected.

13. The communications device of claim 12, wherein said modem is formed on an integrated circuit (IC) comprising a substrate having a semiconductor surface, and wherein said processor comprises a digital signal processor (DSP).

14. The communications device of claim 12, wherein said dynamic MAC IFS selection algorithm implements defining a threshold frame size, and wherein if said frame size is less than or equal to (≦) said threshold frame size, a shorter of said candidate values are selected in said dynamically selecting for said RIFS value and said CIFS value, whereas if said frame size is greater than (>) said threshold frame size, a longer of said candidate values are selected in said dynamically selecting for said RIFS and said CIFS.

15. The communications device of claim 12, wherein said dynamic MAC IFS selection algorithm implements calculating a throughput gain using at least said shorter of said candidate values over using said longer of said candidate values to determine said threshold frame size.

16. The communications device of claim 12, wherein said threshold frame size is based on a maximum frame size parameter defined by a PLC specification used by said PLC network.
